(19) United States
(12) Patent Application Publication
(10) Pub. No.: US 2018/0131740 A1
(43) Pub. Date: May 10, 2018

(54) ANONYMIZING STREAMING DATA

(71) Applicant: GENERAL MOTORS LLC, DETROIT, MI (US)

(72) Inventors: Kannan Ramamurthy, Novi, MI (US); Srinivas R. Morampudi, Troy, MI (US)

(21) Appl. No.: 15/344,220

(22) Filed: Nov. 4, 2016

(51) Int. Cl. H04L 29/06; H04L 29/08

(52) U.S. Cl. CPC H04L 65/602; H04L 65/607; H04L 67/10

(57) ABSTRACT

A system and method of anonymizing streaming data sets includes: processing one or more data sets into one or more anonymous vector representations of those data set(s); accessing a generalized vector that includes a desired level of data anonymization; comparing the anonymous vector representations of the data set(s) with the generalized vector; determining whether the anonymous vector representations of the data set(s) are sufficiently anonymous based on the comparison; identifying a temporal period for sending data sets that are sufficiently anonymous; and increasing or decreasing a quantity of computational resources that determine whether the vector representations of the data set(s) are sufficiently anonymous based on an amount of time remaining in the temporal period.

### TECHNICAL FIELD

The present invention relates to processing data and, more particularly, to anonymizing data sets.

### BACKGROUND

Data sets can be created that each include a plurality of data values. These data sets can describe a wide range of phenomena. For example, data sets can include a plurality of data values associated with a person that describe or relate to that person. That is, the person could be associated with data indicating where that person lives, such as zip code, the person's gender, or age. Data sets can alternatively describe other topics, such as a vehicle and vehicle functions associated with that vehicle. Given that the data sets can include identifying information, they are generally anonymized so that the recipient of such information cannot particularly identify particular data values (e.g., person or vehicle) included in the data set.

Anonymization can occur using k-anonymity techniques to process data sets and render them anonymous. However, k-anonymity is generally applied to static data sets. In contrast, many data sets are now sent as streaming data and anonymizing these streaming data sets can be challenging. When applying existing k-anonymity techniques to streaming data, it may be challenging to identify the optimal amount of anonymity to apply to the data sets to ensure the data is sufficiently anonymous and process the data sets within a defined time requirement.

### SUMMARY

According to an embodiment, there is provided a method of anonymizing streaming data sets. The method includes processing one or more data sets into one or more anonymous vector representations of those data set(s); accessing a generalized vector that includes a desired level of data anonymization; comparing the anonymous vector representations of the data set(s) with the generalized vector; determining whether the anonymous vector representations of the data set(s) are sufficiently anonymous based on the comparison; identifying a temporal period for sending data sets that are sufficiently anonymous; and increasing or decreasing a quantity of computational resources that determine whether the vector representations of the data set(s) are sufficiently anonymous based on an amount of time remaining in the temporal period.

According to another embodiment, there is provided a method of anonymizing streaming data sets. The method includes processing one or more data sets into one or more anonymous vector representations of those data set(s); accessing a generalized vector that includes a desired level of data anonymization; comparing the anonymous vector representations of the data set(s) with the generalized vector; determining whether the anonymous vector representations of the data set(s) are sufficiently anonymous based on the comparison; calculating a rate at which incoming data sets are received; increasing or decreasing a quantity of computational resources that determine whether the vector representations of the data set(s) are sufficiently anonymous based on the rate at which data sets are received; and transmitting data sets that are sufficiently anonymized before a temporal period expires to a third party.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein; and

FIG. 2 is a flow chart depicting an embodiment of a method of anonymizing streaming data sets.

### DETAILED DESCRIPTION OF THE ILLUSTRATED EMBODIMENT(S)

The system and method described below uses k-anonymity techniques to anonymize streaming data sets and ensure that a sufficient level of anonymity exists relative to an optimized level of anonymity. The optimized level of anonymity can be established using a generalized vector. When streaming data sets have been anonymized and are represented by vectors, those vectors can be compared with the generalized vector to determine a computed distance that exists between them. If the computed distance is within an acceptable range of values, the data set can be sufficiently anonymized. The range can have an upper and lower limit to ensure not only that the data set is sufficiently anonymized but also that the system has not removed too much data making the data set less informative than it could be. The range can be determined by the number of times a key from the data set, such as a vehicle identifier, is repeated in a particular data set. If the entire key is provided, then no anonymity exists. Conversely, if the key is redacted or generalized, then the key becomes anonymous. In that way the generalized vector can be controlled to establish an optimum level of anonymity that maintains secrecy but also ensures that the data sets include as much information as possible without compromising that secrecy.

The system also monitors the amount of time remaining in a temporal period allotted to process a defined amount of anonymous data sets and increases or decreases the amount of computing resources dedicated to processing the data sets based on the amount of time and data set processing that remains. Certain software applications may include a requirement that a particular number of anonymized data sets are created and/or transmitted for each defined period of time. During that period of time, the quantity of anonymized data sets that are received from a remote facility may fluctuate over a period of time and the amount of computing resources can be varied in relation to the rate at which data sets that are received. Embodiments of the disclosed method(s) will be described below with respect to a remote facility that wirelessly receives data sets from a plurality of vehicles and provides anonymized data to third parties. However, it should be appreciated that the method(s) could be implemented using other systems than the vehicle/remote facility. For example, the method(s) could alternatively be implemented using a plurality of computers that communicate packetized data via the Internet.

### Communications System

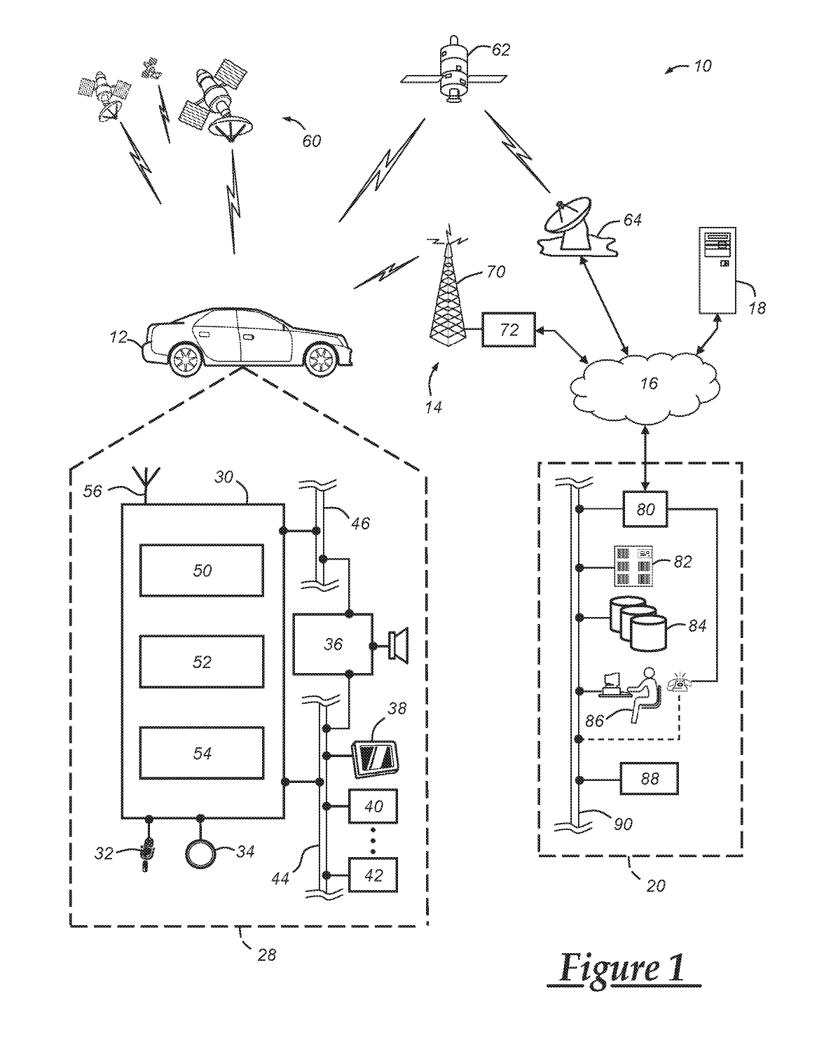

With reference to FIG. 1, there is shown an operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of other vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 is itself a vehicle system module (VSM) and can be implemented as an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM, CDMA, or LTE standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as LTE, EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, including short range wireless communication (SRWC) such as any of the IEEE 802.11 protocols, WiMAX, ZigBee™ Wi-Fi direct, Bluetooth™, or near field communication (NFC). When used for packet-switched data communication such as TCP/IP, the telematics unit can be configured with a static IP address or can be set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the telematics unit 30, audio system 36, and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbutton(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12. The computer 18 includes computational resources in the form of one or more computer processors that can selectively increase or decrease the processing load they carry in response to software instructions. The computer 18 also can include random access memory (RAM) that hosts a data buffer or cache for storing data sets before transmitting them to a third party.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

### Method

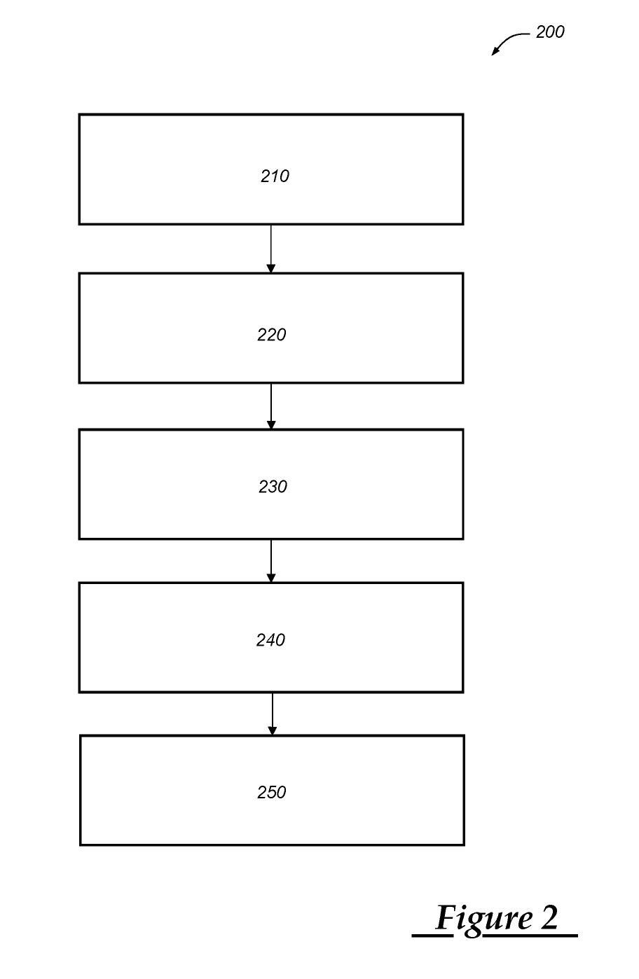

Turning now to FIG. 2, there is shown an embodiment of a method (200) of anonymizing streaming data sets. The method 200 begins at step 210 by processing one or more data sets into one or more anonymous vector representations of those data sets. In this implementation, the vehicle 12 can generate data sets and wirelessly communicate the data sets to a remote facility, such as the computer 18 or call center 20, where the data sets will be processed. Data sets comprise a plurality of data entries that include personally identifying data (PID). The data sets can include one or more identifier or quasi-identifiers data entries and one or more content data entries. This information can be organized into table or matrix form. In one example, each data set can include a vehicle identification number (VIN) of the vehicle 12 as an identifier data entry as well as odometer and oil life values for content data entries associated with the vehicle 12. By way of illustrating these data sets, three exemplary data sets are shown in table form below:

| VIN | ODOMETER | OIL LIFE |
|---|---|---|
| 2GABCDEFGHJKLM234 | 1000 | 10% |
| 2GABCDEFGHJKLM234 | 1500 | 45% |
| 2GABCDEFGHJKLM234 | 2000 | 22% |

The remote facility can receive large volumes of data sets that have been created by many vehicles. Individual vehicles, such as the vehicle 12, can each generate a plurality of data sets and send them to the central facility. The central facility can receive these data sets from the vehicle 12 at the same time as the central facility receives data sets from a large number of other vehicles.

The data sets can be anonymized using the k-anonymity techniques of suppression and generalization. Suppression involves replacing identifier data entries with asterisks or blank spaces while generalization can be carried out by replacing particular data entries with broader ranges or categories. Both of these techniques can be appreciated by a second table shown below that suppresses the identifier data entries and generalizes the content data entries.

| VIN | ODOMETER | OIL LIFE |
|---|---|---|
| * | 1000-1500 | 10-20% |
| * | 1000-1500 | 40-50% |
| * | 1500-2000 | 20-30% |

The data entries shown in the second table that have been generalized can each be represented by a point in space having coordinates. A vector can be created including all of the points representing data entries in a table. This anonymized vector representing the data set can indicate the level of anonymity of the particular data set. The method 200 proceeds to step 220.

At step 220, a generalized vector is accessed that includes a desired level of data anonymization. The generalized vector can be defined based on user input that establishes an ideal or desired level of anonymization. This desired level of anonymization represents what portion of the data set the user deems appropriate to make public. It is possible to view the generalized vector as a start point vector, such that anonymized vector representations of data sets having the same vector as the generalized vector would have no loss of information relative to the desired level of data anonymization. It should be appreciated that anonymization of data occurs away from the vehicle 12. The method 200 proceeds to step 230.

At step 230, the anonymous vector representations of the data set(s) are compared with the generalized vector and it is determined whether the anonymous vector representations of the data set(s) are sufficiently anonymous based on the comparison. As data sets are received at the central facility, the data sets can be anonymized using k-anonymity techniques and converted into vectors in the form of matrices. A linear transformation can then be performed on the matrices with respect to the generalized vector. The central facility can then determine the cosine of the angle between the anonymous vector and the generalized vector. When the cosine of the angle is less than a defined threshold, the central facility can determine that the anonymized data set is sufficiently anonymous. In one implementation, the threshold is 0.3, which indicates that a 30% data loss is acceptable. However, if the cosine of the angle between the anonymous vector and the generalized vector is greater than the defined threshold, the data set can be rejected as not being sufficiently anonymous or too anonymous in that a greater amount of the data entries in the data set have been suppressed or generalized. The central facility can modify the anonymous vector representations and then compare the modified anonymous vector with the generalized vector to ensure that the cosine of the angle is less than the defined threshold. As anonymized data sets are generated at the central facility or received already anonymized from the vehicle 12, the central facility can continue to perform linear transformation on these new anonymized data sets with respect to the generalized vector. Anonymized data sets that have been determined to be sufficiently anonymous can be stored by the central facility in a buffer or data cache until enough data sets have accumulated for sending to or access by a third party. A number of third parties presently exist that can receive the data sets. One example of such a third party is Telogis™. The method 200 proceeds to step 240.

At step 240, a temporal period is determined for sending data sets that are sufficiently anonymous. The central facility may be instructed to send a defined number of data sets to a third party during a defined temporal period. For example, the central facility may be instructed to anonymize 1000 data sets per second. At the start of a temporal period lasting one second, the central facility may be tasked with anonymizing incoming data sets, comparing those anonymized data sets with the generalized vector, identifying the data sets that have been sufficiently anonymized, and storing at least 1000 of the sufficiently anonymized data sets in memory for transmission to the third party. It should be appreciated that the temporal period, the defined number of data sets, or both can differ from the example provided. The method 200 proceeds to step 250

At step 250, a quantity of computational resources that determine whether the vector representations of the data set(s) are sufficiently anonymous are increased or decreased based on an amount of time remaining in the temporal period. The central facility can monitor the amount of data sets it receives per unit time and control the amount of computational resources based on this rate. In one example, if the incoming data sets are each 21 kilobytes (KB) in size and during a first hour 30,000 vehicles each transmit a data set, the central facility will receive 630 gigabytes (GB) of data. As time passes, the number of vehicles transmitting data sets may vary. For example, in the next seven hours, the central facility may receive data sets from an increasing number of vehicles. This example is shown in a table below indicating the size of the data sets, the number of vehicles sending data sets, and the overall amount of data received (in KB) per hour.

| | Bytes | | |
|---|---|---|---|
| Hour | in KB | Vehicles | Data Size |
| 0 | 21 | 30,000 | 630,000 |
| 1 | 21 | 40,000 | 840,000 |
| 2 | 21 | 50,000 | 1,050,000 |
| 3 | 21 | 60,000 | 1,260,000 |
| 4 | 21 | 70,000 | 1,470,000 |
| 5 | 21 | 80,000 | 1,680,000 |
| 6 | 21 | 90,000 | 1,890,000 |
| 7 | 21 | 100,000 | 2,100,000 |
| 8 | 21 | 200,000 | 4,200,000 |
| 9 | 21 | 175,000 | 3,675,000 |
| 10 | 21 | 150,000 | 3,150,000 |
| 11 | 21 | 140,000 | 2,940,000 |
| 12 | 21 | 155,000 | 3,255,000 |
| 13 | 21 | 150,000 | 3,150,000 |
| 14 | 21 | 150,000 | 3,150,000 |
| 15 | 21 | 150,000 | 3,150,000 |
| 16 | 21 | 170,000 | 3,570,000 |
| 17 | 21 | 200,000 | 4,200,000 |
| 18 | 21 | 190,000 | 3,990,000 |
| 19 | 21 | 170,000 | 3,570,000 |
| 20 | 21 | 160,000 | 3,360,000 |
| 21 | 21 | 100,000 | 2,100,000 |
| 22 | 21 | 70,000 | 1,470,000 |
| 23 | 21 | 40,000 | 840,000 |

As time passes, the number of vehicles sending data sets to the central facility fluctuates and the amount of computer processing resources needed to process the data sets varies based on the inflow of data sets. The central facility can plot the amount of data received per unit time and find the slope of the polynomial representing a curve approximating the plotted data points. This polynomial can be sued to represent the flow rate of data sets received by the central facility. The central facility can monitor the amount of data sets that have been anonymized within the temporal period and depending on the amount of data sets that still need to be anonymized and the flow rate of the data sets, increase or decrease the computing resources used to process or anonymize the data sets. Increases in the flow rate of data sets can induce an increase in the amount of computing resources used to process the data sets while a decrease in the flow rate can decrease the amount of computing resources.

The calculated flow rate can be used to measure the size of a buffer needed to store the incoming data sets in memory at the central facility. The buffer can be sharded based on a key, such as an identifier data entry, using a key and hash node combination algorithm. It is possible to determine an amount of force that will slide an anonymized vector out of the buffer. The magnitude (M) of this force (F) about the origin (0) of the vector can be defined as M=Fd where d is the shortest distance from 0 to a line of the force assuming that d is the amount of distance required to push the anonymized vector out of the buffer. The distance d can be calculated based on the flow rate velocity (v) and acceleration (a) at a point in time represented by d=vt+1/2 at², where v and a are determined from the flow rate.

Buffer size can be dependent on factors such as RAM and may be used to temporarily hold the data sets before moving them to an output point, such as a messaging queue that writes the data on to disk. It is helpful to control the buffer size in a way that will move the data sets from a cache buffer to a buffer with anonymous data. This distance can be calculated using the velocity of the incoming data stream. The formula above shows the distance calculation. Since the data is moved from the buffer cache with raw data to buffer cache with anonymized data, the force which is analogous to processing throughput is calculated using moment theory. The method 200 then ends.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of anonymizing streaming data sets, comprising the steps of:
(a) processing one or more data sets into one or more anonymous vector representations of those data set(s);
(b) accessing a generalized vector that includes a desired level of data anonymization;
(c) comparing the anonymous vector representations of the data set(s) with the generalized vector;
(d) determining whether the anonymous vector representations of the data set(s) are sufficiently anonymous based on the comparison;
(e) identifying a temporal period for sending data sets that are sufficiently anonymous; and
(f) increasing or decreasing a quantity of computational resources that determine whether the vector representations of the data set(s) are sufficiently anonymous based on an amount of time remaining in the temporal period.

2. The method of claim 1, wherein the one or more data sets comprise at least one identifier data entry and at least one content data entry.

3. The method of claim 1, wherein each data entry included in the one or more data sets represents a point on the one or more anonymous vector representations

4. The method of claim 1, wherein step (c) further comprises the step of determining the cosine of an angle between the anonymous vector representation and the generalized vector.

5. The method of claim 1, wherein step (d) further comprises the step of comparing the cosine of the angle with a threshold value

6. The method of claim 1, further comprising the step of determining the flow rate of data sets received at a central facility.

7. The method of claim 4, further comprising the step of determining a size of a buffer based on the flow rate of data sets.

8. The method of claim 1, wherein the data sets are processed into anonymous vector representations at a vehicle.

7. A method of anonymizing streaming data sets, comprising the steps of:
(a) processing one or more data sets into one or more anonymous vector representations of those data set(s);
(b) accessing a generalized vector that includes a desired level of data anonymization;
(c) comparing the anonymous vector representations of the data set(s) with the generalized vector;
(d) determining whether the anonymous vector representations of the data set(s) are sufficiently anonymous based on the comparison;
(e) calculating a rate at which incoming data sets are received;
(f) increasing or decreasing a quantity of computational resources that determine whether the vector representations of the data set(s) are sufficiently anonymous based on the rate at which data sets are received; and
(g) transmitting data sets that are sufficiently anonymized before a temporal period expires to a third party.

10. The method of claim 9, wherein the one or more data sets comprise at least one identifier data entry and at least one content data entry.

11. The method of claim 9, wherein each data entry included in the one or more data sets represents a point on the one or more anonymous vector representations

12. The method of claim 9, wherein step (c) further comprises the step of determining the cosine of an angle between the anonymous vector representation and the generalized vector.

13. The method of claim 12, wherein step (d) further comprises comparing the cosine of the angle with a threshold value.

14. The method of claim 9, further comprising the step of determining a size of a buffer based on the rate at which incoming data sets are received.

15. The method of claim 9, wherein the data sets are processed into anonymous vector representations at a vehicle.
